(19) United States
(12) Patent Application Publication
(10) Pub. No.: US 2010/0151168 A1
(43) Pub. Date: Jun. 17, 2010

(54) HOUSING AND METHOD FOR MANUFACTURING THE SAME

(75) Inventors: GANG HUANG, Shenzhen City (CN); YAN-MIN WANG, Shenzhen City (CN); QIN-ZHENG HOU, Shenzhen City (CN); QIANG WANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/553,470

(22) Filed: Sep. 3, 2009

(30) Foreign Application Priority Data
Dec. 12, 2008 (TW) 97148469

(51) Int. Cl. B32B 1/02; B32B 27/00; B32B 37/12

(52) U.S. Cl. 428/35.7; 428/34.1; 156/293

(57) ABSTRACT

A housing comprises a base and a decorative film. The decorative film comprises a transparent substrate and a non-conductive coating. The substrate includes a substrate outer surface opposite to a substrate inner surface. The non-conductive coating is laminated with the substrate covering the substrate inner surface. The base is integrally molded with the decorative film covering the non-conductive coating.

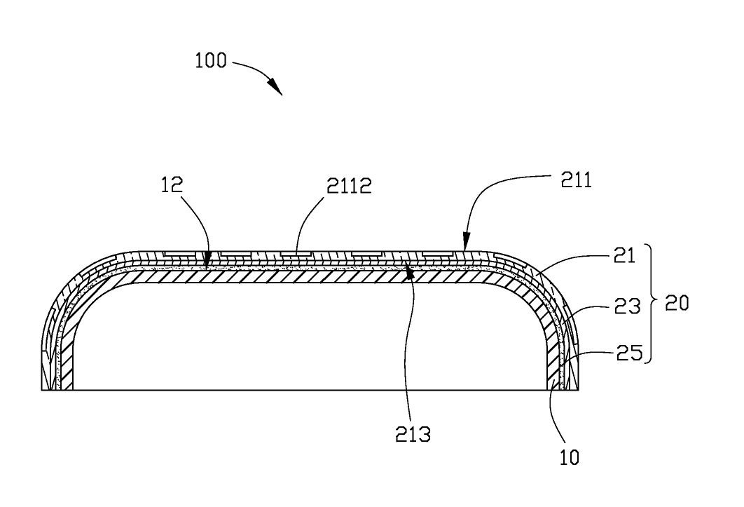

### BACKGROUND

1. Technical Field

The exemplary disclosure generally relates to housings and methods for manufacturing the same, particularly to housings used in portable electronic devices.

2. Description of Related Art

Currently, portable electronic devices with wireless communication capability, such as mobile phones, are widely used. Consumers can choose to purchase a specific model not only based on performance but also other factors, such as appearance.

Often, to offer a pleasing appearance and increased quality of an outer housing, the housing of a portable electronic device is made of a metallic material. However, metallic housings can interfere with communication signals of the portable electronic device.

Therefore, there is a room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary housing and method of manufacturing the housing. Moreover, in the drawings like reference numerals designate corresponding parts throughout the several views. Wherever possible, the same reference numbers are used throughout the drawings to refer to the same or like elements of an embodiment.

The FIGURE is a schematic view of an exemplary embodiment of a housing including a substrate and a decorative film.

### DETAILED DESCRIPTION OF THE EMBODIMENTS

Referring to the FIGURE, an exemplary housing 100 includes a base 10 and a decorative film 20 laminated with the base 10 to entirely cover a base outer surface 12. The decorative film 20 includes a clear, transparent substrate 21, a non-conductive coating 23 and a shading layer 25. The substrate 21 includes a substrate outer surface 211 and a substrate inner surface 213 opposite to the substrate outer surface 211. The substrate 21 has a plurality of patterns 2112 formed on the outer surface 211 thereof. In this embodiment, the patterns 2112 are formed by a plurality of slots defined in the substrate outer surface 211, however, the patterns 2112 may be formed by a plurality of projection strips (not shown) defined on the substrate outer surface 211. The non-conductive coating 23 is laminated by vacuum evaporation or sputtering with the substrate 21 entirely covering the entire substrate inner surface 213. The shading layer 25 is laminated with and entirely covers the entire non-conductive coating 23.

The base 10 is made of a thermoplastic material such as polyethylene, polycarbonate, acrylonitrile bivinyl styrene, polymethyl methacrylate, or any combination thereof. The base 10 is integrally molded on the decorative film 20 entirely covering the entire shading layer 25. It understood that the base 10 will be directly integrally molded with the substrate 21 entirely covering the non-conductive coating 23, when the film 10 does not include the shading layer 19. The material for the substrate 21 may be a resin sheet of a single body or a copolymer of a polypropylene, polyamide, polycarbonate, polymethyl methacrylate or other. The non-conductive coating 23 presents a metallic finish, and may be formed by non conductive vacuum metallization (NCVM). The non-conductive coating 23 is less than about 0.5 micrometers (μm) thick.

For the shading layer 25, an opaque, colored material such as a polyvinyl based resin, a polyamide based resin, a polyester based resin, an acrylic resin, a polyurethane based resin, apolyvinyl acetal based resin, a cellulose ester based resin, or an alkyd resin is preferred as a binder with a colorant containing a pigment or dye of a desired hue. In formation of the shading layer 25, an ordinary ink printing method such as gravure, screen, or offset printing may be used. Further, the shading layer 25 functions as a protecting portion, protecting the non-conductive coating 25 from damage when the base 10 is integrally molded on the decorative film 20.

In a method of manufacturing a housing 100, a substrate 21 is provided that has the patterns 2112 formed thereon by transfer method, using a transfer machine (not shown), such as a roll transfer machine equipped with two opposing heat-proof rubber rollers, one of which includes a plurality of protrusions corresponding to the patterns 2112 of the substrate 21. The transfer machine applies heat and pressure to the substrate 21 via the rollers set at a predetermined pressure and temperature. Accordingly, the patterns 2112 are formed on the substrate 21.

A non-conductive coating 23 is formed by non conductive vacuum metallization on the substrate 21 opposite to the patterns 2112, at a thickness less than 0.5 μm. A shading layer 25 is formed on the substrate 21 by printing opaque, colored material, such as a resin mixed with colored ink, entirely covering the non-conductive coating 23, resulting in a decorative film 20. Finally, a mold (not shown) corresponding to the housing 100 is provided, the decorative film 20 is laid in the mold, and molten plastic or silica gel is injected into the cavity to form a base 10, which is subsequently integrally molded with the decorative film 20 entirely covering the entire shading layer 25, to form the housing 100.

It is to be understood, however, that even though numerous characteristics and advantages of the exemplary disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A housing, comprising:
a base; and
a decorative film, the decorative film comprising a transparent substrate and a non-conductive coating, the substrate comprising a substrate outer surface and a substrate inner surface opposite to the substrate outer surface, the non-conductive coating laminated with the substrate covering the substrate inner surface;
wherein the base is integrally molded with the decorative film covering the non-conductive coating.

2. The housing as claimed in claim 1, wherein the decorative film further comprises a shading layer laminated between the non-conductive coating and the base.

3. The housing as claimed in claim 1, wherein the decorative film further comprises a protective layer laminated between the non-conductive coating and the base.

4. The housing as claimed in claim 1, wherein the non-conductive coating is formed on the substrate by non conductive vacuum metallization.

5. The housing as claimed in claim 1, wherein the non-conductive coating has a thickness less than about 0.5 μm.

6. The housing as claimed in claim 1, wherein the base comprises a thermoplastic material such as polyethylene, polycarbonate, acrylonitrile bivinyl styrene, polymethyl methacrylate, or a combination thereof.

7. The housing as claimed in claim 1, wherein the base is integrally molded on the decorative film entirely covering the non-conductive coating.

8. The housing as claimed in claim 1, wherein the substrate is a resin sheet of a single body or a copolymer of a polypropylene, polyamide, polycarbonate, polymethyl methacrylate.

9. The housing as claimed in claim 1, wherein the substrate comprises a plurality of patterns formed on the substrate outer surface.

10. The housing as claimed in claim 1, wherein the non-conductive coating is formed on an outer surface of the base.

11. A method for manufacturing a housing, comprising:
providing a substrate comprising a substrate inner surface;
forming a non-conductive coating by non conductive vacuum metallization on the substrate inner surfaces; and
attaching a base to the non-conductive coating.

12. The method as claimed in claim 11, wherein the base is integrally molded with the non-conductive coating.

13. The method as claimed in claim 11, further comprising laminating a shading layer with the non-conductive coating before attaching the base to the non-conductive coating.

14. The method as claimed in claim 11, wherein the non-conductive coating has a thickness less than about 0.5 μm.

15. The housing as claimed in claim 11, wherein the base comprises a thermoplastic material such as polyethylene, polycarbonate, acrylonitrile bivinyl styrene, polymethyl methacrylate, or a combination thereof.

16. The housing as claimed in claim 11, wherein the base is integrally molded on the decorative film entirely covering the entire non-conductive coating.

17. The housing as claimed in claim 11, wherein the substrate is a resin sheet of a single body or a copolymer of a polypropylene, polyamide, polycarbonate, polymethyl methacrylate.

18. The housing as claimed in claim 11, wherein the substrate comprises a plurality of patterns formed on the substrate outer surface.

19. The method as claimed in claim 11, further comprising laminating a protective layer with the non-conductive coating before attaching the base to the non-conductive coating.
